(19) United States
(12) Patent Application Publication
(10) Pub. No.: US 2026/0214153 A1
(43) Pub. Date: Jul. 23, 2026

(54) MULTI-COMPONENT CASES FOR MOBILE DEVICES

(71) Applicant: Urban Armor Gear, LLC, Laguna Niguel, CA (US)

(72) Inventors: Eric Yoshinari, Laguna Niguel, CA (US); Hyun Hong, Murrieta, CA (US)

(21) Appl. No.: 19/451,645

(22) Filed: Jan. 16, 2026

Related U.S. Application Data
(60) Provisional application No. 63/746,547, filed on Jan. 17, 2025.

(51) Int. Cl. H04M 1/02

(52) U.S. Cl. CPC H04M 1/0203

(57) ABSTRACT

A mobile device case includes a plurality of interconnecting components that, when interconnected, form a multi-component inner body. The multi-component inner body includes a first back wall and a plurality of first side walls that define an opening configured to securely house a mobile device. The mobile device case also includes an outer body comprising a second back wall and a plurality of second side walls that define an opening configured to securely house the multi-component inner body.

### PRIORITY

This application claims priority to and the benefit of U.S. Provisional Patent Application 63/746,547, filed Jan. 17, 2025, the entire contents of which are incorporated herein by reference.

### TECHNICAL FIELD

The present disclosure generally relates to mobile devices and, more specifically, multi-component cases for mobile devices.

### BACKGROUND

Mobile devices, such as smartphones and tablets, have become ubiquitous. Oftentimes, mobile devices are held in the hand of a user while the user moves about by foot, by bicycle, in a car or other motorized vehicle, etc. Mobile devices are also often held when capturing image(s) and/or video and may be held in precarious positions, such as over a balcony or cliff, out a window, etc. In the event that the user loses their grip on the mobile device, the mobile device could fall and impact the ground or another hard surface, potentially damaging the mobile device.

Mobile devices can be placed inside an impact-resistant case to reduce or even prevent damage to the mobile device from an impact. However, in some instances, the force of a large impact may cause the case to separate from the mobile device, leaving the mobile device vulnerable to any subsequent impacts. Additionally, a mobile device having a complex shape can be more difficult to secure within an impact-resistant case.

### SUMMARY

The appended claims define this application. The present document discloses aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for multi-component cases for mobile devices.

An example mobile device case disclosed herein includes a plurality of interconnecting components that, when interconnected, form a multi-component inner body. The multi-component inner body includes a first back wall and a plurality of first side walls that define an opening configured to securely house a mobile device. The mobile device case includes an outer body comprising a second back wall and a plurality of second side walls that define an opening configured to securely house the multi-component inner body.

An example multi-component case disclosed herein includes a first component and a second component that are interconnected to form a rigid inner body having an opening configured to securely house a mobile device. The multi-component case also includes a first snap-fit connector configured to secure the first component to the second component. The multi-component case also includes a flexible outer body having an opening configured to securely house the rigid inner body. The multi-component case also includes a second snap-fit connector configured to secure the rigid inner body within the flexible outer body.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is a rear view of an example multi-component case housing a smartphone in accordance with one example embodiment of the present disclosure.

FIG. 2 is left rear perspective view of the multi-component case of FIG. 1.

FIG. 3 is a right rear perspective view of the multi-component case of FIG. 1.

FIG. 4 is a front view of the multi-component case of FIG. 1, showing an inner body and an outer shell of the multi-component case.

FIG. 5 is a left front perspective view of the multi-component case of FIG. 1.

FIG. 6 is an exploded, left front perspective view of the multi-component case of FIG. 1.

FIG. 7 is a rear view of the inner case and the outer shell of the multi-component case of FIG. 1.

FIG. 8 is a left front perspective view of an example multi-component case in accordance with an alternative embodiment of the present disclosure.

FIG. 9 is an exploded, left front perspective view of the multi-component case of FIG. 8, showing an outer body and front and rear components of an inner body.

FIG. 10 is an exploded, left front perspective view of the outer body and the front component of the inner body of FIG. 9.

### DETAILED DESCRIPTION

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Example mobile device cases disclosed herein are configured to securely house and/or couple to mobile devices (e.g., tablets, smartphones, etc.). Each of the mobile device cases disclosed herein includes a multi-component inner body and an outer body and is configured to protect the mobile device from physical impacts (e.g., impacting a hard surface at a velocity of 40 feet per second), without interfering with handheld use of the mobile device.

In various embodiments, the multi-component inner body includes two or more interconnecting components that, when interconnected, form the inner body. By using separate components to form the inner body, the inner body can be assembled around protrusions of the mobile device, such as a camera bump, instead of a single piece component that is bent or stretched over the camera bump. This enables the components of the inner body to be formed from more rigid materials, rather than flexible materials needed to bend or stretch around the camera bump. Using rigid materials for the inner body enables the inner body to spread a force from an impact over a larger area of the mobile device, which can reduce impact damage to the mobile device. The outer body, formed from a more flexible and impact-absorbing material, can then be assembled around the inner body to provide further protection.

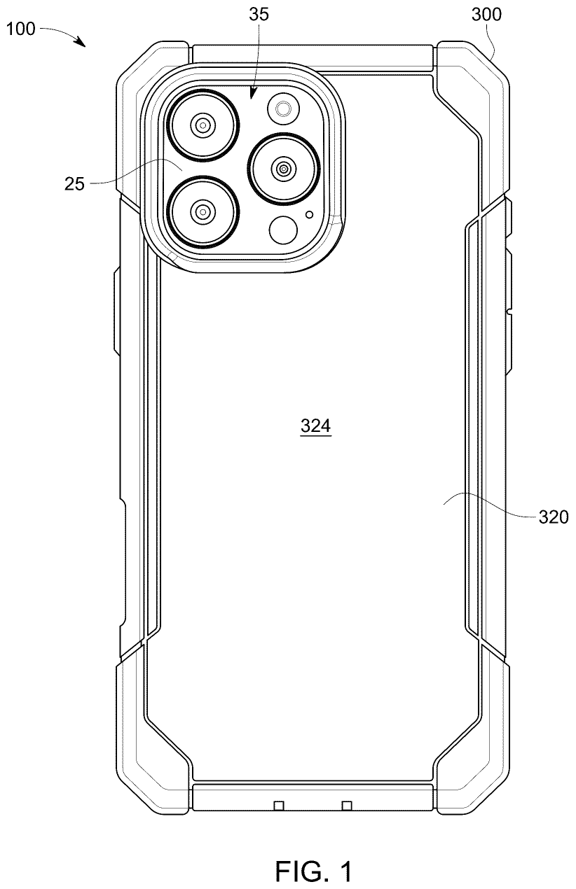

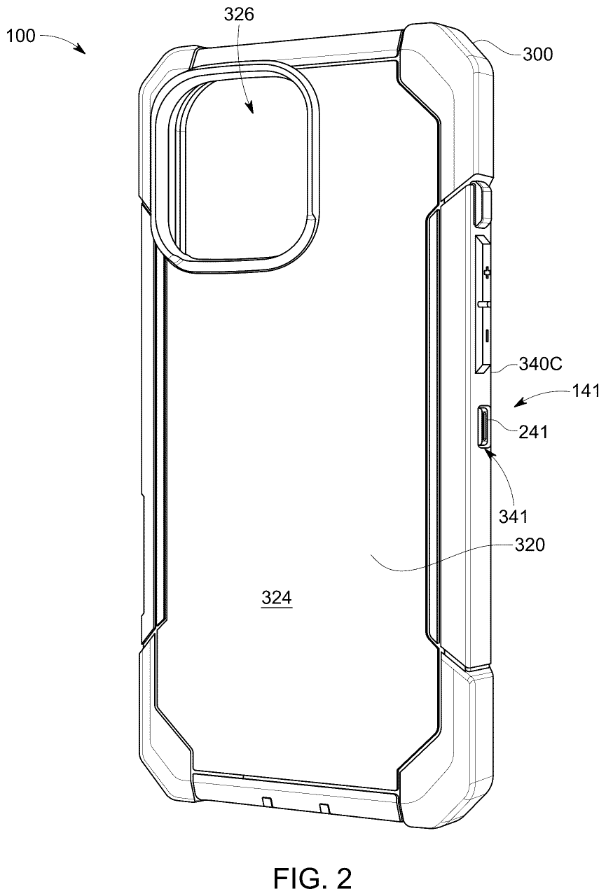

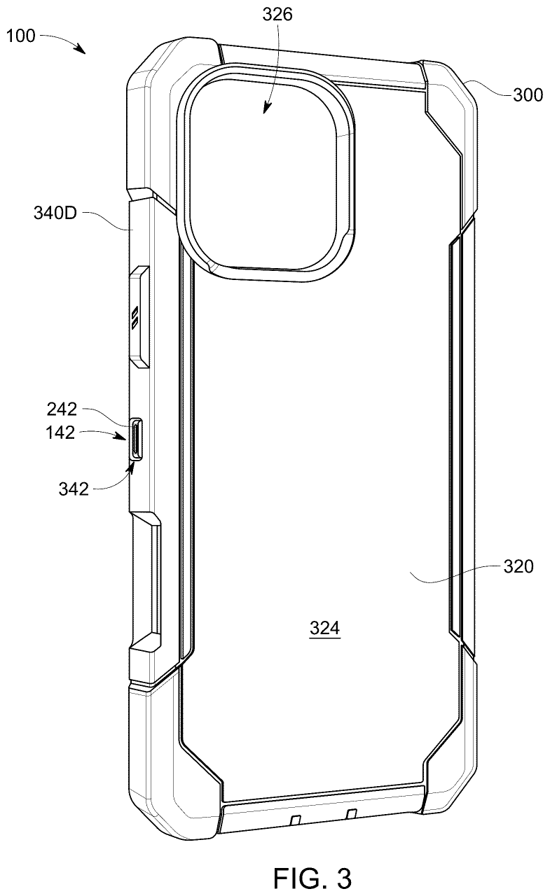

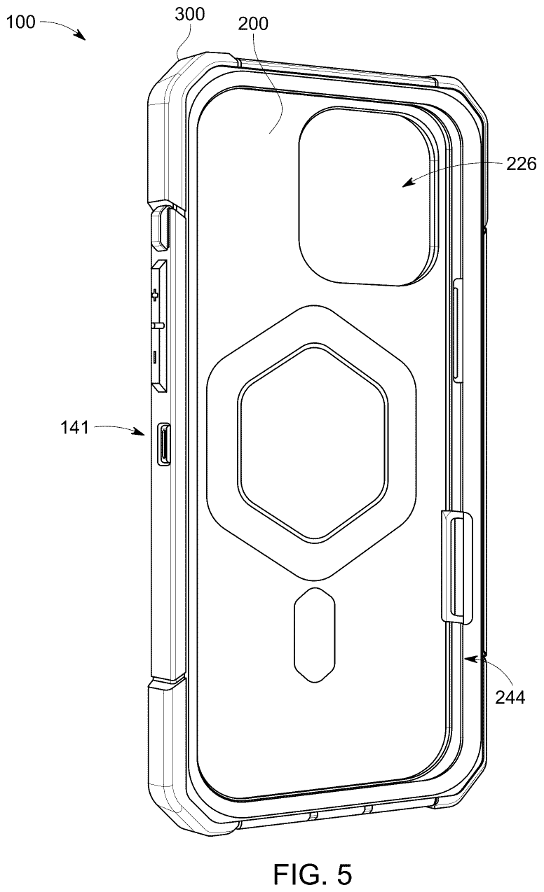

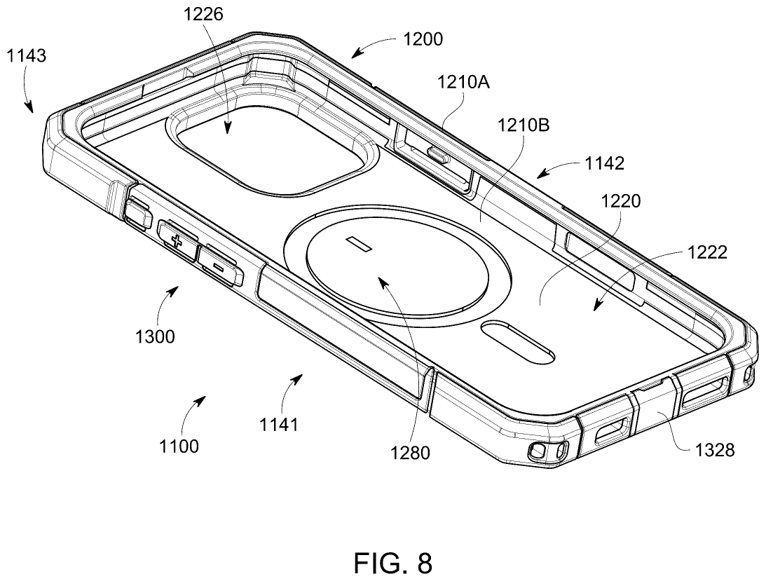

Turning to the figures, FIGS. 1 to 7 depict an example multi-component case 100 for a smartphone 25 and/or other mobile device in accordance with the teachings herein. FIGS. 8 to 10 depict an example multi-component case 1100 for the smartphone 25 and/or other mobile device in accordance with an alternative embodiment of the teachings herein.

The multi-component case 100 (also referred to as a “case” for brevity) includes an inner body 200 and an outer body 300. The inner body 200 is a multi-component body and includes two or more separate components that are interconnectable with each other to form the inner body 200, while the outer body 300 is a one piece body. In the example multi-component case 100, the inner body 200 includes an upper component 210A and a lower component 210B. That is, the example multi-component case 100 includes three separate components: the upper component 210A of the inner body 200, the lower component 210B of the inner body 200, and the outer body 300.

As described further in the example shown in FIGS. 1 to 7, the inner body 200 includes the upper component 210A and the lower component 210B (also referred to as a “first component” and “second component”) such that the combination of the inner body 200 secured to the outer body 300 provides improved protection of the smartphone 25. In various embodiments, the inner body 200 includes polycarbonate, polyoxymethylene, other suitable thermoplastics, carbon fiber reinforced polymer (“carbon fiber”), other fiber reinforced polymers (e.g., fiberglass reinforced nylon), and/or other suitable materials for structural strength and rigidity (e.g., having a relatively high modulus of elasticity). In various embodiments, the outer body 300 includes thermoplastic polyurethane (TPU), silicone, and/or other suitable material for impact resistance (e.g., having a relatively low modulus of elasticity compared to the material of the inner body 200). Other materials for the inner body 200 and the outer body 300 can be used in other embodiments, but generally the material of the inner body 200 has a higher modulus of elasticity than the materials of the outer body 300.

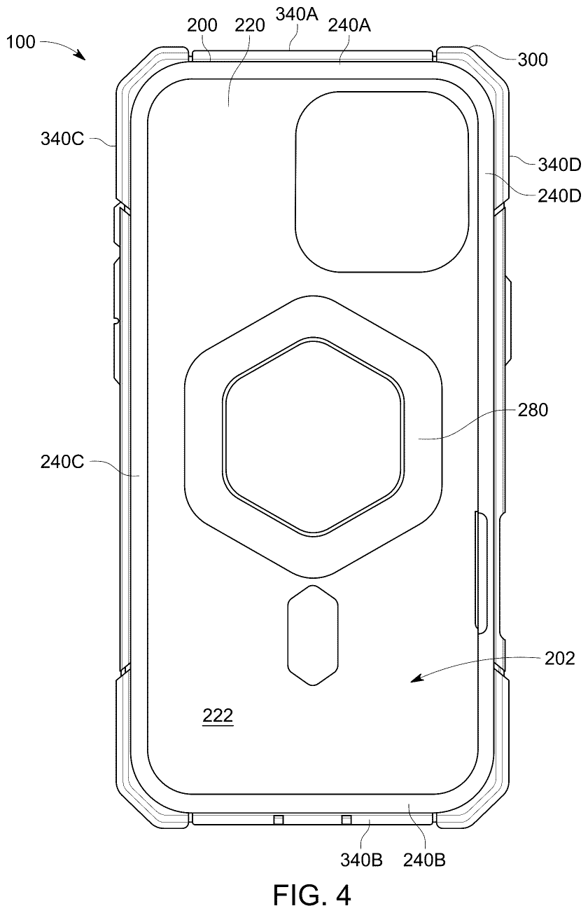

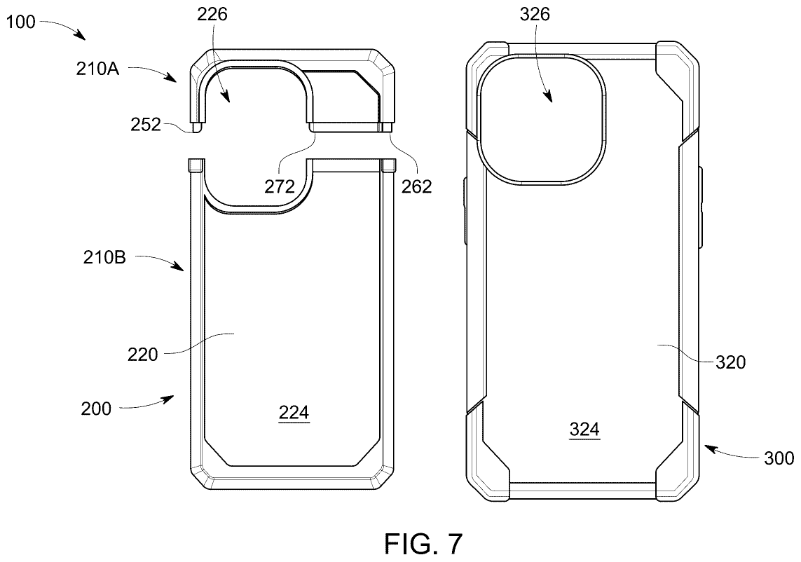

The inner body 200 includes a back wall 220 and a plurality of a side walls. In the figures, the plurality of side walls is shown as side wall 240A, 240B, 240C, and 240D (also referred to herein collectively as the “side walls 240” for brevity). The back wall 220 includes a front side 222 (i.e., facing the smartphone 25) and a back side 224 (FIGS. 4 and 7).

The front side 222 of the back wall 220 and the side walls 240 define a cavity or opening 202 in which the smartphone 25 is secured. The inner body 200 is configured to cover the sides and back of the smartphone 25 to protect the smartphone 25 from the environment, including protection from impacts with objects, hard surfaces, the ground, etc. As shown in FIG. 1, the back wall 220 defines a camera hole 226 for a camera 35 of the smartphone 25 or other suitable components (e.g., a camera flash device, an ambient light sensor). In various embodiments, the back wall 220 and/or the side walls 240 define one or more additional holes (not labeled) to facilitate user interaction with one or more components of the smartphone 25, such as buttons, switches, speakers, microphones, data and charging ports (e.g., a Universal Serial Bus port), SIM card trays, memory card trays, or other suitable components of the smartphone 25. In certain embodiments, the back wall 220 includes a magnet 280, for example, to facilitate wireless charging and/or accessory attachments for the smartphone 25.

In various embodiments, the inner body 200 includes one or more structural features, fasteners, and/or connectors that secure the smartphone 25 within the opening 202, for example, to promote retention of the smartphone 25 within the case during forceful motions (e.g., a physical impact). In the embodiment shown in the figures, the plurality of side walls 240 include an inner lip 244 configured to secure the smartphone 25 within the opening 202. The inner lip 244 extends around an inner perimeter of the side walls 240 along an outer edge of the smartphone 25 and extends partially over a front face (i.e., a screen) of the smartphone 25. Other configurations of the inner lip 244 and other means to secure the smartphone 25 within the opening 202 are contemplated and within the scope of the present disclosure.

As shown in FIGS. 1 to 6, the outer body 300 extends along and covers the side walls 240 to provide impact protection to the side walls 240 of the inner body 200. The outer body 300 also extends along and covers portions of the back side 224 of the back wall 220 to provide impact protection to the back wall 220. That is, the outer body 300 is configured to provide impact protection to the inner body 200 and thus to the smartphone 25 within the inner body 200.

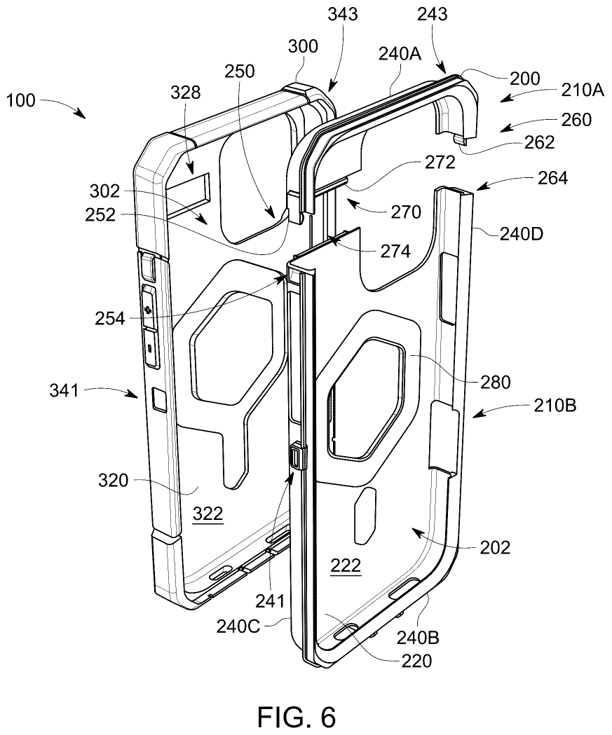

The outer body 300 includes a back wall 320 and a plurality of a side walls. In the figures, the plurality of side walls is shown as side walls 340A, 340B, 340C, and 340D (also referred to herein collectively as the “side walls 340” for brevity). The back wall 320 includes a front side 322 and a back side 324 (FIGS. 6 and 7).

The front side 322 of the back wall 320 and the side walls 340 define an opening 302 in which the inner body 200 and the smartphone 25 are secured. As shown in FIG. 1, the back wall 320 defines a camera hole 326 for the camera 35 of the smartphone 25, similar to the camera hole 226 of the inner body 200. In various embodiments, the back wall 320 and/or the side walls 340 define one or more additional holes (not labeled) to facilitate user interaction with one or more components of the smartphone 25, as described above.

In various embodiments, the case 100 includes one or more structural features, fasteners, and/or connectors that secure the inner body 200 within the outer body 300. In certain embodiments, the case 100 includes one or more snap-fit connectors that enable a tool-free assembly and securement of the inner body 200 within the outer body 300. The snap-fit connectors can include a tab and a corresponding hole or slot into which the tab is insertable, a tab and a corresponding recess, a ridge and a corresponding slot, and/or other suitable snap-fit configuration. In the embodiment shown in the figures, the case 100 includes a left side snap-fit connector 141, a right side snap-fit connector 142, and a perimeter snap-fit connector 143.

In certain embodiments, the left side snap-fit connector 141 includes a tab 241 located on the side wall 240C of the inner body 200 and a corresponding hole 341 located on the side wall 340C of the outer body 300. In certain embodiments, the tab 241 is rigid and the hole 341 is configured to stretch around the tab 241 to facilitate insertion of the tab 241 into the hole 341. The hole 341 then returns to its original shape to retain the tab 241 and secure the inner body 200 to the outer body 300. In other embodiments, the tab 241 is flexible and bends inward (i.e., toward the opposite side wall 240D) to facilitate the insertion, then returns to its original shape. In other embodiments, both the tab 241 and the hole 341 are flexible to facilitate the insertion. The right side snap-fit connector 142 is analogous to the left side snap-fit connector 141 and includes a tab 242 located on the side wall 240D and a corresponding hole 342 located on the side wall 340D.

The perimeter snap-fit connector 143 includes an outer ridge 243 of the inner body 200 and an inner slot 343 of the outer body 300 configured to receive and retain the outer ridge 243. In the example shown in FIG. 6, the outer ridge 243 extends around an entire outer perimeter of the side walls 240 and the inner slot 343 extends around an entire inner perimeter of the side walls 340. In other embodiments, the outer ridge 243 and the inner slot 343 are discontinuous around the perimeter, for example, formed only on two or three side walls, formed only on a portion of a sidewalls, etc.

As described above, the inner body 200 is a multi-component body and includes the upper component 210A and the lower component 210B. These components are configured to securely interconnect with each other to form the inner body 200 as a rigid structure, or semi-rigid structure. When interconnected, the upper component 210A and lower component 210B define the opening 202 in which the smartphone 25 is securely housed. In some embodiments, each of the components of the inner body 200 is formed from a same material. In other embodiments, the components of the inner body 200 are formed from different materials. For example, a component that includes a tab can be formed from a more flexible material than a component that includes a corresponding recess for the tab, enabling the tab to more easily bend during assembly.

In certain embodiments, an individual component of the inner body 200 is formed from two or more different materials that are secured together. For example, the upper component 210A can include a rigid material for a first portion (e.g., the back wall 220) and a flexible material for a second portion (e.g., the side walls 240). In such embodiments, the different portions can be joined using adhesives, plastic welding, or other suitable techniques. In certain embodiments, an individual component of the inner body 200 is formed from a same material, but with different properties in different portions. For example, the upper component 210A can include a first region of carbon fiber with higher strength than a second region of carbon fiber (e.g., due to a different fiber weave pattern and/or different numbers of fiber weave layers).

By using separate components to form the inner body 200, installation of the inner body 200 around the smartphone 25 is simplified because any stretching of the inner body 200 needed to enable the inner body 200 to wrap around edges of the smartphone 25 is reduced and/or eliminated. Additionally, or alternatively, any stretching of the inner body 200 needed to enable the inner body 200 to wrap around a camera bump or other protrusion of the smartphone 25 is reduced and/or eliminated. With a reduced need for stretchability of the inner body 200 to fit around the smartphone 25, the inner body 200 can be formed from more rigid materials to provide improved protection, less expensive materials with a lower elasticity, etc. Additionally, a shape of the inner body 200 can be more closely matched to a shape of the smartphone 25 (or to a desired shape to support the smartphone 25), enabling a tighter and more secure fit of the inner body 200 around the smartphone 25.

In various embodiments, two or more of the components of the inner body 200 are configured to, when interconnected, form a hole or opening through which a user can utilize the smartphone 25. For example, a first component forms one side of the hole and a second component, when interconnected with the first component, forms an opposing side of the hole. In certain embodiments, a portion of the smartphone 25 extends partially into the formed hole. In certain such embodiments, the interconnected components form a plurality of interior side walls that abut the portion of the smartphone 25 extending into the formed hole. In the example embodiment shown in the figures, the upper component 210A and the lower component 210B form the camera hole 226, through which the camera 35 can be used to capture images, with interior side walls that wrap around the camera bump of the smartphone 25.

The inner body 200 includes one, two, or more snap-fit connectors that enable the assembly and secure interconnection of the components of the inner body 200. The snap-fit connectors enable a tool-free assembly of the components of the inner body 200 and hold the components of the inner body 200 together. Each snap-fit connector includes opposing elements, such as a tab and a corresponding recess into which the tab is insertable, a tab and a corresponding slot or hole, a ridge and a corresponding slot, and/or other suitable snap-fit configuration. In various embodiments, the snap-fit connectors of the inner body 200 are located on one or more of the side walls 240 and/or the back wall 220. In the example shown in the figures, the inner body 200 includes a left wall snap-fit connector 250 located on the side wall 240C, a right wall snap-fit connector 260 located on the side wall 240D, and a back wall snap-fit connector 270 located on the back wall 220.

For the left wall snap-fit connector 250, a portion of the side wall 240C of the upper component 210A includes a tab 252 and a portion of the side wall 240C of the lower component 210B includes a corresponding recess 254. In other words, each of a first side wall portion of the upper component 210A and a first side wall portion of the lower component 210B include one of the opposing elements of the left wall snap-fit connector 250. Similarly, for the right wall snap-fit connector 260, a portion of the side wall 240D of the upper component 210A includes a tab 262 and the side wall 240D of the lower component 210B includes a corresponding recess 264. For the back wall snap-fit connector 270, a portion of the back wall 220 of the upper component 210A includes a tab 272 and a portion of the back wall 220 of the lower component 210B includes a corresponding slot 274.

As described above, the inner body 200 is formed from multiple components that are interconnected using the snap-fit connectors (e.g., tabs and recesses). In certain scenarios, employing a snap-fit connector to connect two components that form the inner body 200 increases a total volume of material for those components as compared to a single, integral inner body. For example, forming a suitably strong and durable slot 274 to receive the corresponding tab 272 of the snap-fit connector 270 on the back wall 220 of the lower component 210B may require additional material for reinforcement to be added to the back wall 220 as compared to a back wall for a single component inner body. In certain embodiments, the outer body 300 includes one or more connector cavities into which all or a portion of this additional material of the snap-fit connector is accommodated. In the example shown in FIG. 6, the front side 322 of the rear wall 320 includes a connector cavity 328 in which the tab 272 and slot 274 of the snap-fit connector 270 are accommodated. Although the connector cavity 328 may reduce an overall thickness of the back wall 320, the connector cavity 328 reduces and/or eliminates any protrusion in an outer surface of the case 100 associated with the snap-fit connector 270, which can provide a more uniform surface for improved grip and/or improved visual appeal of the case 100.

In certain embodiments, two or more of the snap-fit connectors are integrally formed. In some such embodiments, a snap-fit connector that secures the inner body 200 to the outer body 300 is integrally formed with a snap-fit connector that secures the components of the inner body 200 to each other. As one example, the outer ridge 243 of the perimeter snap-fit connector 143 includes a recess of the snap-fit connector 250. In this example, at least some additional material for the outer ridge 243 is utilized for both the snap-fit connector 143 and the snap-fit connector 250 and reduces a total material needed to form the inner body 200.

Other configurations and/or quantities of the snap-fit connectors of the inner body 200 that secure the components of the inner body 200 together are contemplated and within the scope of the present disclosure. In certain embodiments, the third snap-fit connector 270 is omitted and only the snap-fit connectors 250 and 260 on the side walls are provided. In certain embodiments, the snap-fit connectors 250 and 260 on the side walls are omitted and only the snap-fit connector 270 is provided. In certain embodiments, additional snap-fit connectors are provided (e.g., two separate snap-fit connectors on the back wall 220). In some embodiments, different tabs and recesses can be located on either of the upper component 210A and/or the lower component 210B. For example, the upper component 210A can include a tab for a first snap-fit connector and a recess for a second snap-fit connector while the lower component 210B includes a recess for the first snap-fit connector and a tab for the second snap-fit connector.

Other configurations and/or quantities of the snap-fit connectors 141, 142, and 143 are contemplated and within the scope of the present disclosure. In certain embodiments, for example, the inner body 200 includes holes and/or recesses of one or more snap-fit connectors and the outer body 300 includes corresponding tabs for those snap-fit connectors.

In certain embodiments, the case 100 includes one or more friction fit connectors (not shown), such as a cylindrical post and a cylindrical hole into which the post is insertable, alternatively or in addition to any of the snap-fit connectors. In some such embodiments, a friction fit connector includes a bullet-nose post and/or a tapered hole into which the post is insertable to facilitate alignment of the components of the inner body 200 as the components are assembled together. In certain embodiments, the case 100 includes one or more other fasteners, alternatively or in addition to any of the snap-fit connectors. In some such examples, the inner body 200 is formed with a threaded hole or a threaded insert configured to receive a screw or other fastener that secures the components of the inner body 200 together, secures the inner body 200 to the outer body 300, etc.

It should be appreciated that the inner body 200 and the outer body 300 can vary in accordance with the present disclosure. For example, the inner body 200 and the outer body 300 can employ different quantities, sizes, and shapes of the holes that facilitate usage of the smartphone, such as the camera hole, the USB hole, etc. Although the example components of the inner body 200 are described as the upper component 210A and the lower component 210B, in other embodiments, the components can include a left component and a right component, or other suitable combinations of components.

Referring now to FIGS. 8 to 10, an example multi-component case 1100 for the smartphone 25 and/or other mobile device according to an alternative embodiment employs a different configuration of interconnecting components that form its inner body. The multi-component case 1100 (also referred to as a “case” for brevity) includes an inner body 1200 and an outer body 1300. The inner body 1200 is a multi-component body and includes two or more separate components that form the inner body 1200, while the outer body 1300 is a one piece body. In the example multi-component case 1100, the inner body 1200 includes a front component 1210A and a rear component 1210B. That is, the example multi-component case 100 includes three separate components: the front component 1210A of the inner body 1200, the rear component 1210B of the inner body 1200, and the outer body 1300.

As shown further in the example shown in FIGS. 8 to 10, the inner body 1200 includes the front component 1210A and the rear component 1210B (also referred to as a “first component” and “second component”) such that the combination of the inner body 1200 secured to the outer body 1300 provides improved protection of the smartphone 25. In various embodiments, the inner body 1200 includes polycarbonate, polyoxymethylene, other suitable thermoplastics, carbon fiber reinforced polymer (“carbon fiber”), other fiber reinforced polymers (e.g., fiberglass reinforced nylon), and/or other suitable materials for structural strength and rigidity (e.g., having a relatively high modulus of elasticity). In various embodiments, the outer body 1300 includes thermoplastic polyurethane (TPU), silicone, and/or other suitable material for impact resistance (e.g., having a relatively low modulus of elasticity compared to the material of the inner body 1200). Other materials for the inner body 1200 and the outer body 1300 can be used in other embodiments, but generally the material of the inner body 1200 has a higher modulus of elasticity than the materials of the outer body 1300.

The rear component 1210B includes a back wall 1220 and a plurality of side walls. In the figures, the plurality of side walls is shown as side wall 1240A, 1240B, 1240C, and 1240D (also referred to herein collectively as the “side walls 1240” for brevity). The back wall 1220 includes a front side 1222 (i.e., facing the smartphone 25) and a back side 1224. The front component 1210A includes a plurality of side walls that form a screen opening for a touch-screen display of the smartphone 25. In the figures, this plurality of side walls is shown as side wall 1242A, 1242B, 1242C, and 1242D (also referred to herein collectively as the “side walls 1242” for brevity).

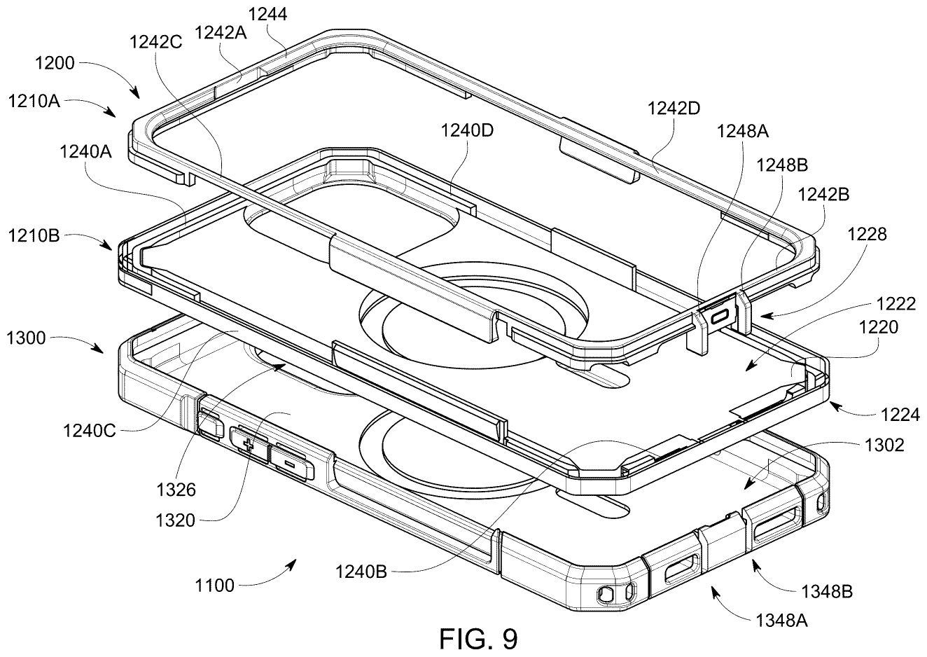

The front side 1222 of the back wall 1220, the side walls 1240, and the side walls 1242 define a cavity or opening 1202 in which the smartphone 25 is secured. The inner body 1200 is configured to cover the sides and back of the smartphone 25 to protect the smartphone 25 from the environment, including protection from impacts with objects, hard surfaces, the ground, etc. As shown in FIG. 9, the back wall 1220 defines a camera hole 1226 for the camera 35 of the smartphone 25 (i.e., a rear-facing camera) or other suitable components (e.g., a camera flash device, an ambient light sensor). In certain embodiments, the back wall 1220 includes a magnet 1280, for example, to facilitate wireless charging and/or accessory attachments for the smartphone 25.

In various embodiments, the back wall 1220 and/or the side walls 1240 and 1242 define one or more additional holes, such as communication port hole 1228 to facilitate user interaction with one or more components of the smartphone 25, such as buttons, switches, speakers, microphones, data and charging ports (e.g., a Universal Serial Bus port), SIM card trays, memory card trays, or other suitable components of the smartphone 25.

In various embodiments, the side wall 1242B includes fins that protrude outward from the side wall 1242B. In some embodiments, the fins provide improved support near the communication port hole 1228. In some embodiments, the fins secure the front component 1210A within the outer body 1300 when assembled. In the example embodiment shown in FIG. 9, the side wall 1242B includes two fins 1248A and 1248B (collectively, the “fins 1248”) that extend between the front and rear of the inner body 1200 and protrude through corresponding slots 1348A and 1348B of the outer body 1300. The fins 1248 are configured to provide improved stiffness to the inner body 1200 in an area near the communication port of the smartphone 25. Other variations of the fins 1248, such as fins that extend between the side walls 1240C and 1240D, additional fins located near structurally weaker sections of the smartphone 25 or near other components of the smartphone 25 (e.g., the speakers, buttons, memory card trays) are contemplated and within the scope of the present disclosure.

In various embodiments, the inner body 1200 includes one or more structural features, fasteners, and/or connectors that secure the smartphone 25 within the opening 1202, for example, to promote retention of the smartphone 25 within the case during forceful motions (e.g., a physical impact). In the embodiment shown in FIGS. 8 to 10, the plurality of side walls 1242 include an inner lip 1244 configured to secure the smartphone 25 within the opening 1202. The inner lip 1244 extends around an inner perimeter of the side walls 1240 (or a portion thereof) along an outer edge of the smartphone 25 and extends partially over a front face (i.e., a screen) of the smartphone 25. Other configurations of the inner lip 1244 and other means to secure the smartphone 25 within the opening 1202 are contemplated and within the scope of the present disclosure.

As shown in FIGS. 8 to 10, the outer body 1300 extends along and covers the side walls 1240 and 1242 to provide impact protection to the side walls 1240 and 1242 of the inner body 1200. The outer body 1300 also extends along and covers portions of the back side 1224 of the back wall 1220 to provide impact protection to the back wall 1220. That is, the outer body 1300 is configured to provide impact protection to the inner body 1200 and thus to the smartphone 25 within the inner body 1200.

The outer body 1300 includes a back wall 1320 and a plurality of a side walls. In the embodiment shown in FIGS. 8 to 10, the plurality of side walls is shown as side walls 1340A, 1340B, 1340C, and 1340D (also referred to herein collectively as the “side walls 1340” for brevity). The back wall 1320 includes a front side 1322 and a back side 1324.

The front side 1322 of the back wall 1320 and the side walls 1340 define an opening 1302 in which the inner body 1200 and the smartphone 25 are secured. The back wall 1320 defines a camera hole 1326 for the camera 35 of the smartphone 25, similar to the camera hole 1226 of the inner body 1200. In various embodiments, the back wall 1320 and/or the side walls 1340 define one or more additional holes (not labeled) to facilitate user interaction with one or more components of the smartphone 25, as described above.

In certain embodiments, the outer body 1300 includes a communication port cover 1328 that flexibly covers the communication port hole 1228 of the front component 1210A and corresponding communication port of the smartphone 25. The outer body 1300 includes the slots 1348A and 1348B that accommodate the fins 1248 and form the communication port cover 1328. In the example embodiment shown in FIGS. 8 to 10, the communication port cover 1328 is flexible and is operable to be bent outwards to reveal the communication port hole 1228.

In various embodiments, the case 1100 includes one or more structural features, fasteners, and/or connectors that secure the inner body 1200 within the outer body 1300. In certain embodiments, the case 1100 includes one or more snap-fit connectors that enable a tool-free assembly and securement of the inner body 1200 within the outer body 1300. The snap-fit connectors can include a tab and a corresponding hole or slot into which the tab is insertable, a tab and a corresponding recess, a ridge and a corresponding slot, and/or other suitable snap-fit configuration. In the embodiment shown in FIGS. 8 to 10, the case 1100 includes a left side snap-fit connector 1141, a right side snap-fit connector 1142, and a perimeter snap-fit connector 1143.

In certain embodiments, the left side snap-fit connector 1141 includes a tab 1251 located on the side wall 1242C of the inner body 1200 and a corresponding angled recess 1351 located on the exterior of the side wall 1340C of the outer body 1300. The angled recess 1351 extends inward towards the opening 1202 and is angled to become deeper towards the back wall 1320. In certain embodiments, the tab 1251 is rigid and the recess 1351 is configured to compress to facilitate assembly of the tab 1251 over a front lip of the angled recess 1351. The recess 1351 then returns to its original shape to retain the tab 1251 and secure the inner body 1200 to the outer body 1300. In other embodiments, the tab 1251 is flexible and bends outward (i.e., away from the opposite side wall 1240D) to facilitate the assembly, then returns to its original shape. In other embodiments, both the tab 1251 and the angled recess 1351 are flexible to facilitate the assembly.

The right side snap-fit connector 1142 is analogous to the left side snap-fit connector 1141 and includes a tab 1252 located on the side wall 1240D and a corresponding angled recess 1352 located on the exterior of the side wall 1340D.

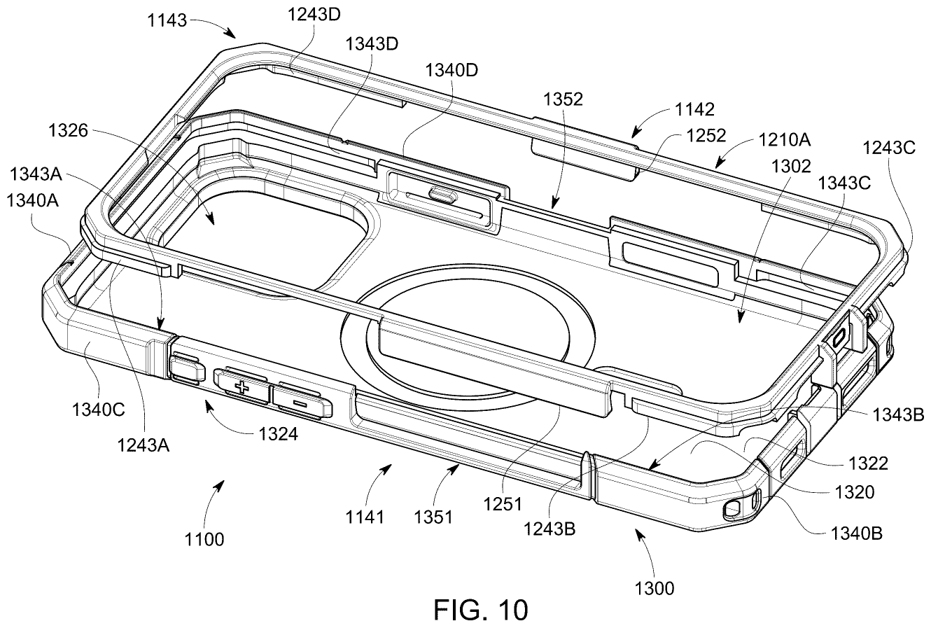

The perimeter snap-fit connector 1143 includes an outer ridge 1243 of the front component 1210A and an inner slot 1343 of the outer body 1300 configured to receive and retain the outer ridge 1243. In the example shown in FIG. 10, the outer ridge 1243 extends around the corners of the outer perimeter of the side walls 1240 (shown as outer ridge 1243A, 1243B, 1243C, and 1243D) and the inner slot 1343 extends around the corners of the inner perimeter of the side walls 1340 (shown as inner slot 1343A, 1343B, 1343C, 1343D). Other variations of the perimeter snap-fit connector 1143 are contemplated and within the scope of the present disclosure.

In various embodiments for assembly with the smartphone 25, the smartphone 25 is placed onto the rear component 1210B, then the front component 1210A is placed onto the rear component 1210B to encapsulate the smartphone 25 between the front and rear components 1210A and 1210B (i.e., within the inner body 1200. The inner body 1200 and smartphone 25 are then inserted into the outer body 1300. During this insertion: (1) portions of the side walls 1340 of the outer body 1300 near the inner slots 1343 flex and/or compress outwardly to accommodate the corresponding outer ridges 1243 of the front component 1210A; (2) portions of the side walls 1340 near the angled recesses 1351 and 1352 flex and/or compress inwardly to accommodate the corresponding tabs 1251 and 1252 of the front component 1210A; and/or (3) portions of the side walls 1240 near the angled recesses 1351 and 1352 flex and/or compress inwardly to accommodate the tabs 1251 and 1252. Once the inner body 1200 is seated within the opening 1302, the portions of the side walls 1340 return to their original shape to interconnect and secure the front and rear components 1210A and 1210B of the inner body 1200 within the opening 1302 of the outer body 1300.

In some embodiment, the front and rear components 1210A and 1210B are configured to securely interconnect with each other to form the inner body 1200 as a rigid structure, or semi-rigid structure. When interconnected, the front component 1210A and rear component 1210B define the opening 1202 in which the smartphone 25 is securely housed. In some embodiments, each of the components of the inner body 1200 is formed from a same material. In other embodiments, the components of the inner body 1200 are formed from different materials. For example, a component that includes a tab can be formed from a more flexible material than a component that includes a corresponding recess for the tab, enabling the tab to more easily bend during assembly.

In certain embodiments, an individual component of the inner body 1200 is formed from two or more different materials that are secured together. For example, the rear component 1210B can include a rigid material for a first portion (e.g., the back wall 1220) and a flexible material for a second portion (e.g., the side walls 1240). In such embodiments, the different portions can be joined using adhesives, plastic welding, or other suitable techniques. In certain embodiments, an individual component of the inner body 1200 is formed from a same material, but with different properties in different portions. For example, the front component 1210A and/or rear component 1210B can include a first region of carbon fiber with higher strength than a second region of carbon fiber (e.g., due to a different fiber weave pattern and/or different numbers of fiber weave layers).

By using separate components to form the inner body 1200, installation of the inner body 1200 around the smartphone 25 is simplified because any stretching of the inner body 1200 needed to enable the inner body 1200 to wrap around edges of the smartphone 25 is reduced and/or eliminated. Additionally, or alternatively, any stretching of the inner body 1200 needed to enable the inner body 1200 to wrap around a camera bump or other protrusion of the smartphone 25 is reduced and/or eliminated. With a reduced need for stretchability of the inner body 1200 to fit around the smartphone 25, the inner body 1200 can be formed from more rigid materials to provide improved protection, less expensive materials with a lower elasticity, etc. Additionally, a shape of the inner body 1200 can be more closely matched to a shape of the smartphone 25 (or to a desired shape to support the smartphone 25), enabling a tighter and more secure fit of the inner body 1200 around the smartphone 25.

In the example embodiment shown in FIGS. 8 to 10, the inner body 1200 includes the front component 1210A and the rear component 1210B, which generally protect a front portion of the smartphone 25 (i.e., near a display screen) and a rear portion of the smartphone 25. With this configuration, the front component 1210A can be formed to more securely wrap around edges of the smartphone 25, such as near the camera bump of the smartphone 25.

Other configurations and/or quantities of the snap-fit connectors 1141, 1142, and 1143 are contemplated and within the scope of the present disclosure. In certain embodiments, for example, the inner body 1200 includes holes and/or recesses of one or more snap-fit connectors and the outer body 1300 includes corresponding tabs for those snap-fit connectors.

In various embodiments, the inner body 1200 includes one, two, or more snap-fit connectors that enable the assembly and secure interconnection of the components of the inner body 1200. In some embodiments, the snap-fit connectors are analogous to the snap-fit connectors 250, 260, and 270 but with their corresponding tabs and recesses oriented to face each other. The snap-fit connectors enable a tool-free assembly of the components of the inner body 1200 and hold the components of the inner body 1200 together. Each snap-fit connector includes opposing elements, such as a tab and a corresponding recess into which the tab is insertable, a tab and a corresponding slot or hole, a ridge and a corresponding slot, and/or other suitable snap-fit configuration. In various embodiments, the snap-fit connectors of the inner body 1200 are located on one or more of the side walls 1240 and/or side walls 1242. Other configurations and/or quantities of the snap-fit connectors of the inner body 1200 that secure the components of the inner body 1200 together are contemplated and within the scope of the present disclosure. In some embodiments, the inner body 1200 includes one, two, or more friction fit connectors alternatively or in addition to any of the snap-fit connectors.

It should be appreciated that the inner body 1200 and the outer body 1300 can vary in accordance with the present disclosure. For example, the inner body 1200 and the outer body 1300 can employ different quantities, sizes, and shapes of the holes that facilitate usage of the smartphone, such as the camera hole, the USB hole, etc. Although the example components of the inner body 1200 are described as the front component 1210A and the rear component 1210B, in other embodiments, the components can include a left component and a right component, or other suitable combinations of components.

Exemplary embodiments in accordance with the teachings herein are disclosed below.

An example mobile device case includes a plurality of interconnecting components and an outer body. When interconnected, the plurality of interconnecting components form a multi-component inner body. The multi-component inner body includes a back wall and a plurality of a side walls that define an opening configured to securely house a mobile device. The outer body includes a back wall and a plurality of side walls that define an opening configured to securely house the multi-component inner body.

In some examples, the plurality of interconnecting components include a first snap-fit connector that secures two adjacent interconnecting components together. In some such examples, the mobile device case further includes a second snap-fit connector that secures the multi-component inner body to the outer body. In some such examples, the first snap-fit connector and the second snap-fit connector are integrally formed.

In some examples, the plurality of interconnecting components includes an upper component and a lower component. In some such examples, the upper component and the lower component each includes a portion of a side wall of the plurality of side walls that defines the opening configured to securely house the mobile device. In some such examples, the portion of the side wall of the upper component includes one element of the first snap-fit connector and the portion of the side wall of the lower component includes an opposing element of the first snap-fit connector.

In some examples, the upper component and the lower component include the first snap-fit connector and a second snap-fit connector that secure the upper component and the lower component together. In some such examples, the first snap-fit connector is located on a first side wall portion of the upper component and a first side wall portion of the lower component. The second snap-fit connector is located on a second side wall portion of the upper component and a second side wall portion of the lower component. In some such examples, the upper component and the lower component include a third snap-fit connector that secures the upper component and the lower component together and is located on a rear wall portion of the upper component and a rear wall portion of the lower component.

In some examples, the multi-component inner body includes a camera hole. The upper component forms a first interior side wall of the camera hole and the lower component forms a second interior side wall of the camera hole.

An example multi-component case includes a first component and a second component that are interconnected to form a rigid inner body having an opening configured to securely house a mobile device. The multi-component case also includes a first snap-fit connector configured to secure the first component to the second component. The multi-component case also includes a flexible outer body having an opening configured to securely house the rigid inner body. The multi-component case also includes a second snap-fit connector configured to secure the rigid inner body within the flexible outer body.

In some examples, the first component includes a top wall, a rear wall portion, a left wall portion, and a right wall portion. The second component includes a bottom wall, a rear wall portion, a left wall portion, and a right wall portion. In some such examples, the rear wall portion of the first component and the rear wall portion of the second component include the first snap-fit connector. In some such examples, the left wall portion of the first component and the left wall portion of the second component include a third snap-fit connector configured to secure the first component to the second component. The right wall portion of the first component and the right wall portion of the second component include a fourth snap-fit connector configured to secure the first component to the second component.

In some examples, the flexible outer body includes a connector cavity configured to accommodate the first snap-fit connector.

In some examples, the rear wall portion of the first component includes a first interior side wall of a camera opening for the mobile device. The rear wall portion of the second component includes a second interior side wall of the camera opening for the mobile device.

In some examples, the first component and the second component include the first snap-fit connector and a second snap-fit connector that secure the first and second components together. In some such examples, the first snap-fit connector is located on a first side wall portion of the first component and a first side wall portion of the second component. The second snap-fit connector is located on a second side wall portion of the first component and a second side wall portion of the second component. In some such examples, the first component and the second component include a third snap-fit connector that secures the first and second components together and is located on a rear wall portion of the first component and a rear wall portion of the second component.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A mobile device case, comprising:
a plurality of interconnecting components that, when interconnected, form a multi-component inner body, the multi-component inner body comprising a first back wall and a plurality of first side walls that define an opening configured to securely house a mobile device;
an outer body comprising a second back wall and a plurality of second side walls that define an opening configured to securely house the multi-component inner body.

2. The mobile device case of claim 1, wherein the plurality of interconnecting components comprise a first snap-fit connector that secures two adjacent interconnecting components together.

3. The mobile device case of claim 2, further comprising a second snap-fit connector that secures the multi-component inner body to the outer body.

4. The mobile device case of claim 3, wherein the first snap-fit connector and the second snap-fit connector are integrally formed.

5. The mobile device case of claim 2, wherein the plurality of interconnecting components comprises an upper component comprising an upper portion of the first back wall and a lower component comprising a lower portion of the first back wall.

6. The mobile device case of claim 5, wherein the upper component and the lower component each comprise a portion of a same side wall of the plurality of first side walls that defines the opening configured to securely house the mobile device.

7. The mobile device case of claim 6, wherein the portion of the same side wall of the upper component comprises one element of the first snap-fit connector and the portion of the same side wall of the lower component comprises an opposing element of the first snap-fit connector.

8. The mobile device case of claim 5, wherein the upper component and the lower component comprise the first snap-fit connector and a second snap-fit connector that secure the upper component and the lower component together.

9. The mobile device case of claim 8, wherein:
the first snap-fit connector is located on a first side wall portion of the upper component and a first side wall portion of the lower component; and
the second snap-fit connector is located on a second side wall portion of the upper component and a second side wall portion of the lower component.

10. The mobile device case of claim 9, wherein the upper component and the lower component comprise a third snap-fit connector that secures the upper component and the lower component together and is located on a rear wall portion of the upper component and a rear wall portion of the lower component.

11. The mobile device case of claim 5, wherein:
the multi-component inner body comprises a camera hole;
the upper component forms a first interior side wall of the camera hole;
the lower component forms a second interior side wall of the camera hole; and
the upper portion of the first back wall and the lower portion of the first back wall form the camera hole when interconnected.

12. The mobile device case of claim 1, wherein the plurality of interconnecting components comprises a rear component comprising a camera hole for a rear-facing camera of the mobile device and a front component comprising a screen opening for a touch-screen display of the mobile device.

13. A multi-component case, comprising:
a first component and a second component that are interconnected to form a rigid inner body having an opening configured to securely house a mobile device;
a first snap-fit connector configured to secure the first component to the second component;
a flexible outer body having an opening configured to securely house the rigid inner body;
a second snap-fit connector configured to secure the rigid inner body within the flexible outer body.

14. The multi-component case of claim 13, wherein:
the first component comprises a top wall, a rear wall portion, a left wall portion, and a right wall portion;
the second component comprises a bottom wall, a rear wall portion, a left wall portion, and a right wall portion.

15. The multi-component case of claim 14, wherein the rear wall portion of the first component and the rear wall portion of the second component comprise the first snap-fit connector.

16. The multi-component case of claim 15, wherein:
the left wall portion of the first component and the left wall portion of the second component comprise a third snap-fit connector configured to secure the first component to the second component; and
the right wall portion of the first component and the right wall portion of the second component comprise a fourth snap-fit connector configured to secure the first component to the second component.

17. The multi-component case of claim 15, wherein the flexible outer body comprises a connector cavity configured to accommodate the first snap-fit connector.

18. The multi-component case of claim 14, wherein:
the rear wall portion of the first component comprises a first interior side wall of a camera opening for the mobile device;
the rear wall portion of the second component comprises a second interior side wall of the camera opening for the mobile device.

19. The multi-component case of claim 13, wherein:
the first component and the second component comprise the first snap-fit connector and a second snap-fit connector that secure the first and second components together;
the first snap-fit connector is located on a first side wall portion of the first component and a first side wall portion of the second component; and
the second snap-fit connector is located on a second side wall portion of the first component and a second side wall portion of the second component.

20. The multi-component case of claim 19, wherein the first component and the second component comprise a third snap-fit connector that secures the first and second components together and is located on a rear wall portion of the first component and a rear wall portion of the second component.
